(19) United States
(12) Patent Application Publication
(10) Pub. No.: US 2004/0008525 A1
(43) Pub. Date: Jan. 15, 2004

(54) LED electric bulb

(75) Inventor: Yoshihiko Shibata, Tokyo (JP)

Correspondence Address: ARENT FOX KINTNER PLOTKIN & KAHN, PLLC, 1050 Connecticut Avenue, N.W., Suite 400, Washington, DC, 20036-5339, US

(73) Assignees: HAKUYO DENKYUU KABUSHIKI KAISHA: FUSO DENKI KOUGYOU KABUSHIKI KAISHA; METRO DENKI KOUGYOU KABUSHIK KAISHA

(21) Appl. No.: 10/190,501

(22) Filed: Jul. 9, 2002

(51) Int. Cl. H01J 1/88

(52) U.S. Cl. 362/800; 362/240; 313/271

(57) ABSTRACT

When a number of conventional LED lamps are arranged on a wiring board and are placed in an electric bulb, it is not possible to use a printed wiring board larger than an internal diameter of a base mounting part of the electric bulb, so that a quantity of obtained light is limited. Further, light can be emitted only from a wiring printed surface, which serves as an arrangement surface of LED lamps, of the printed wiring board, so that the range of emitted light is limited. An LED chain body 2 formed by connecting a plurality of LED lamps 3 via flexible members 4 is inserted into a hollow body 1a constituting an electric bulb main body 1.

### BACKDROUND OF THE DEVICE

1. Field of the Device

The present device relates to an LED electric bulb using LED lamps or LED chips as a light source.

2. Description of the Related Art

In general, an incandescent lamp comprising a filament as a light source has a large quantity of generated heat, high power consumption, and a short life. In order to solve these problems, it has been considered that an LED lamp is used instead of a filament as a light source of an electric bulb. The LED lamp has a small quantity of generated heat, low power consumption, and a long life.

### SUMMARY OF THE DEVICE

However, a single LED lamp is small in light quantity and cannot be directly used as a light source of an electric bulb. Although it has been considered that a number of LED lamps are placed on a printed wiring board to obtain a light quantity, it is not possible to use a printed wiring board larger than an internal diameter of a base mounting part of an electric bulb, so that a quantity of obtained light is limited. Further, light can be emitted only from a wiring printed surface, which serves as an arrangement surface of LED lamps, of the printed wiring board, so that the range of emitted light is limited.

Therefore, in view of the above-described problems, the present device has as its object the provision of an LED electric bulb which can obtain a desired quantity of light and a desired range of emission.

In order to solve the above-described problems, the present device is characterized in that an LED chain body formed by connecting a plurality of LED lamps via flexible members is inserted into a hollow body constituting an electric bulb main body.

With this configuration, the flexible members of the LED chain body are bent or twisted so as to form the LED chain body into a desired shape. Thus, a number of LED lamps or LED chips can be placed in the hollow body through a base mounting part so as to obtain a desired quantity of light. Moreover, the flexible members of the LED chain body are bent or twisted so as to direct the LED lamps or the LED chips at various angles, thereby obtaining a desired range of emission.

Further, members other than a filament of an incandescent lamp may be used as they are, the members including a hollow body composed of a glass bulb, a base, and a stem, and the stem may support the LED chain body instead of the filament. Hence, it is possible to manufacture electric bulbs in the same process as that of incandescent lamps, and additional cost including investment in plants and equipment is not necessary for manufacturing electric bulbs.

Moreover, in the present device, a quantity of heat generated in emission is not as large as that of the filament. Thus, the hollow body constituting the electric bulb main body may be made of transparent or translucent resin. Therefore, the range of selecting a material of the hollow body is widened, and electric bulbs can be readily obtained in various shapes.

### BRIEF DESCRIPTION OF THE DRAWINGS

FIG. 1 is a diagram showing the configuration of one embodiment of the present device;

FIG. 2 is a diagram showing the configuration of an LED light source for lighting; and

FIG. 3 is a diagram showing the configuration of another embodiment of the present device.

### DETAILED DESCRIPTION OF PREFERRED EMBODIMENTS

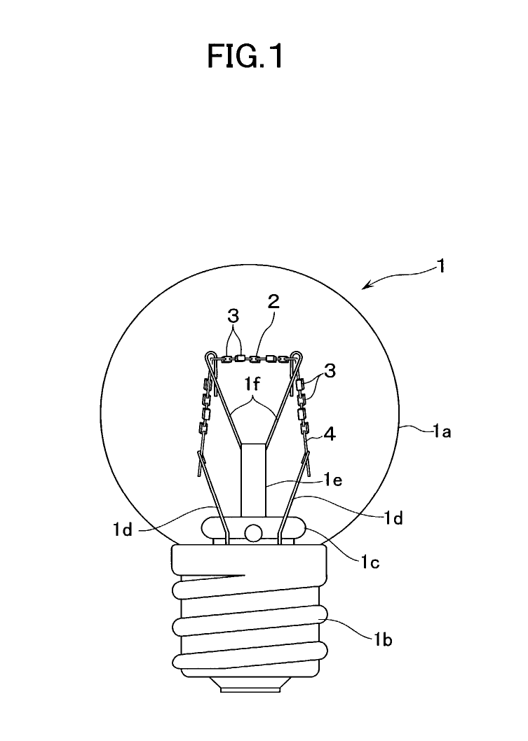

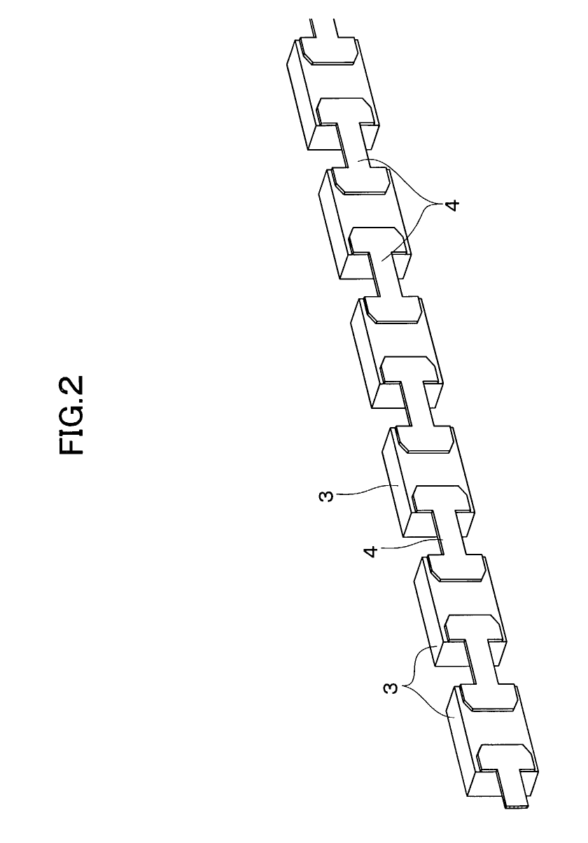

Referring to FIG. 1, reference numeral 1 denotes an electric bulb main body, which is used for a typical incandescent lamp and has a glass bulb 1a as a hollow body, a base 1b, and a stem 1c. Here, in an incandescent lamp, a filament is supported by the stem 1c. In contrast, in the present embodiment, the stem 1c supports an LED chain body 2 instead of a filament, and both ends of the LED chain body 2 are respectively connected to two internal lead-in wires 1d, which extend into the glass bulb 1a from the stem 1c. As shown in FIG. 2, the LED chain body 2 is configured such that a plurality of LED lamps 3, which are formed by embedding LED chips in transparent bodies, are connected in series via flexible members 4, which are composed of thin metallic plates (e.g., copper plates with a thickness of 0.1 mm). Referring to FIG. 1, in the LED chain body 2, the flexible members 4 composed of plate members are twisted so as to slightly shift distribution of light between the adjacent LED lamps 3, and the flexible members 4 are bent at two points so as to work the LED chain body 2 entirely into the shape of a reversed letter U. A hub 1e is provided on the stem 1c in the glass bulb 1a, and two anchors 1f extend into the glass bulb 1a from the hub 1e. The anchors 1f support the two bent points of the LED chain body 2.

Here, the LED chain body 2 is formed by connecting the LED lamps. The LED chain body 2 may be formed by connecting LED chips instead of the LED lamps directly via the flexible members.

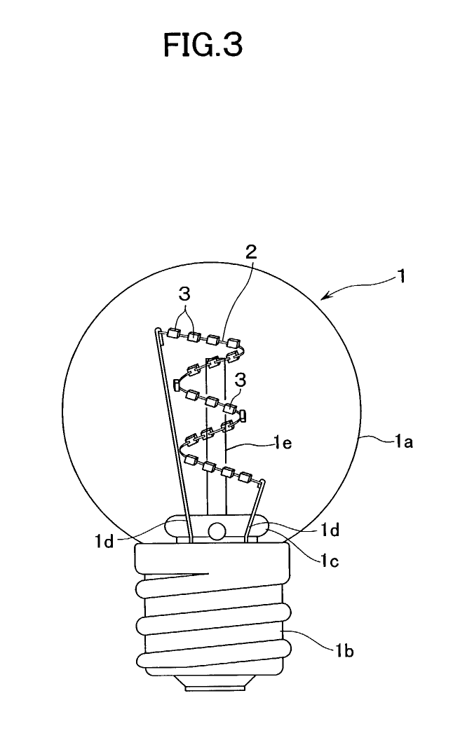

Besides, as shown in FIG. 3, instead of the LED chain body 2 in the form of a reversed letter U of the above-described embodiment, an LED chain body 2 entirely worked in a spiral fashion may be supported by the stem 1c. In the LED chain body 2, the light-distribution surfaces of the LED lamps 3 are directed outward by bending and twisting the flexible members 4 composed of plate members.

Additionally, the above-described embodiment discussed the LED electric bulb which uses the electric bulb main body 1 comprising the glass bulb 1a. Instead of the glass bulb 1a, it is possible to use a hollow body formed by performing injection molding, extrusion, and the like on transparent or translucent resin (e.g., polycarbonate, acrylic, and polychlorinated biphenyl). In this case, a material such as a diffusing material and a fluorescent material can be mixed in a molding material during molding.

As is evident from the above explanation, according to the present device, a number of LED lamps or LED chips can be placed in a hollow body, thereby obtaining a desired quantity of light. Further, the LED lamps or LED chips can be directed at various angles, thereby obtaining a desired range of emission. Also, since members such as a hollow body, a base, and a stem of an incandescent lamp can be used as they are, electric bulbs can be manufactured in the same process as that of incandescent lamps. Thus, additional cost including investment in plants and equipment is not necessary for manufacturing electric bulbs. Moreover, instead of glass, transparent or translucent resin can be used as a material of the hollow body, so that the range of selecting a material of the hollow body is widened, and electric bulbs can be readily obtained in various shapes.

What is claimed is:

1. An LED electric bulb, characterized in that an LED chain body formed by connecting a plurality of LED lamps via flexible members is placed in a hollow body constituting an electric bulb main body.

2. The LED electric bulb according to claim 1, characterized in that members other than a filament of an incandescent lamp are used as they are, the members including a hollow body composed of a glass bulb, a base, and a stem, and the stem supports the LED chain body instead of the filament.

3. The LED electric bulb according to claim 1, characterized in that the hollow body constituting the electric bulb main body is made of transparent or translucent resin.
